(19) United States
(12) Patent Application Publication
(10) Pub. No.: US 2017/0235936 A1
(43) Pub. Date: Aug. 17, 2017

(54) SECURE CREDENTIAL SERVICE FOR CLOUD PLATFORM APPLICATIONS

(71) Applicant: NetSuite Inc., San Mateo, CA (US)

(72) Inventors: Juan de los Rios, Berkeley, CA (US); John Cherniavsky, San Jose, CA (US); Douglas H. Williams, Capitola, CA (US)

(73) Assignee: NetSuite Inc., San Mateo, CA (US)

(21) Appl. No.: 13/968,724

(22) Filed: Aug. 16, 2013

Related U.S. Application Data
(60) Provisional application No. 61/691,092, filed on Aug. 20, 2012.

(51) Int. Cl. G06F 21/36

(52) U.S. Cl. CPC G06F 21/36

(57) ABSTRACT

A system, apparatuses, and methods for enabling a third party application installed on a multi-tenant platform to utilize an external service, where that service requires a user to provide authentication credentials, without exposing those credentials to the third party application. The invention enables an extension of the platform's services, applications, and functionality via the use of the third party application and the external service, but without the risk that the application might expose the credentials to misuse or otherwise cause a breach of the security measures applicable to the data and/or services of a tenant, a tenant's users, or the platform itself.

### CROSS REFERENCE TO RELATED APPLICATION

This application claims the benefit of U.S. Provisional Application No. 61/691,092, entitled “Secure Credential Exchange For Cloud Platform Applications,” filed Aug. 20, 2012, which is incorporated herein by reference in its entirety for all purposes.

### BACKGROUND

In addition to the advantages related to customer access that are provided by the Internet, the ability of business users to access crucial business information has been greatly enhanced by the use of IP-based networking together with advances in object oriented Web-based programming and browser technology. Using these advances, systems have been developed that permit web-based access to business information systems, thereby allowing a user with a browser and an Internet or intranet connection to view, enter, or modify the desired business information. For example, substantial efforts have been directed to Enterprise Resource Planning (ERP) systems that integrate the capabilities of several historically separate business computing systems into a common system, with a goal of streamlining business processes and increasing efficiencies on a business-wide level. By way of example, the capabilities or modules of an ERP system may include one or more of: accounting, order processing, time and billing, inventory management, employee management/payroll, and employee calendaring and collaboration, as well as reporting and analysis capabilities relating to these functions.

Substantial efforts have also been directed to integrated Customer Relationship Management (CRM) systems, with a goal of obtaining a better understanding of customers, enhancing service to existing customers, and acquiring new, profitable customers. By way of example, the capabilities or modules of a CRM system may include one or more of: sales force automation (SFA), marketing automation, contact list management, call center support, and web-based customer support, as well as reporting and analysis capabilities relating to these functions. With differing levels of overlap with ERP/CRM initiatives and with each other, efforts have also been directed toward development of increasingly integrated partner and vendor management systems, eCommerce systems, product lifecycle management (PLM) systems, and supply chain management (SCM) systems.

One computing architecture that may be used to enable user access to ERP, CRM, and other business information systems is a cloud-based computer platform or network. Such a platform or network is typically comprised of multiple servers that are capable of running one or more business related applications. Some cloud-based service platforms are multi-tenant, meaning that they are capable of providing access to one or more business related applications (and the associated data) to more than one business entity or sets of users. The service platform may thus provide a system or suite of functionality that is used by the tenants to provide benefits to their respective users (which may be employees of a tenant, customers of a tenant, etc.). For example, the tenants may include business enterprises that use the service platform to provide various business functions to their employees and customers. Such service platforms may be customizable to various degrees, and tenants may desire to customize the platform to provide distinctive services to their respective users or to groups of those users.

Tenant customization may include custom functionality (such as the capability to perform tenant or user-specific functions, data processing, or operations) built on top of lower level operating system services. However, some modern multi-tenant service platforms may offer the ability to customize functions or operations at a number of different levels of the service platform, from aesthetic modifications to a graphical user interface to providing integration of components and/or entire applications (collectively, an “app” or “apps”) developed by independent third party vendors. This can be very beneficial, since by allowing third party vendors, a multi-tenant service can significantly enhance the functionality available to tenants. However, this development also creates important issues with respect to system and data security.

For example, a third party application may desire to interact with a service that is external to the multi-tenant service platform (“external service”) on behalf of a tenant and/or one of the tenant's users. Examples of such an external service may include a service provided by a bank (such as account maintenance functions), an accounting service, a service provided by a government agency (such as a government revenue collection agency or government regulatory agency), a social media service (which might be used to access information from a feed, or send information to a feed), a credit card processing service, a package shipping service, or a utility service (such as a web-based service that charges a fee for use or can be used to access account data). However, in order to access the external service, the third party application may need to prove to the external service that it is authorized to act on behalf of the user, for example, by participating in an authentication process using the user's credentials.

A problem this may create is that while the functionality of such an application may be desirable, providing the user's credentials to the third party application can create a potentially serious security risk since the third party application may not exercise the same controls on use and protection of the credentials as the user or service platform. For example, the third party application may permit the credentials to be accessed under different and less stringent conditions than would the user or platform. As a result of these less stringent controls on access to the credentials, the third party application may unintentionally permit the security of the tenant data to be compromised, with the result that the data is accessed by an improper entity. In an even more serious security breach, the services or data of other tenants might be improperly accessed or the operations of the platform might be compromised.

Conventional attempts to enable third party applications to act on behalf of a tenant and/or a tenant's user in a secure manner have proven to be inefficient, ineffective, and/or have undesirable side effects or other drawbacks with respect to at least one significant use case. For example, users are typically reluctant to provide sensitive data (such as user names or passwords) to a third party. This means that a user may be unwilling to utilize or permit a platform to utilize the services of a third party unless all interactions with that third party are carried out as part of the operations of the platform itself. Unfortunately, this may be impractical since it may require modifications of the platform that are expensive, time consuming, or undesirable for another reason.

Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the present methods and systems for providing a secure credential service for a cloud-based platform, and introduces some of the concepts that are further described in the Detailed Description section below. This summary is not intended to identify key or essential features of the claimed subject matter, nor is it intended to be used to determine the scope of the claimed subject matter. The subject matter should be understood by reference to appropriate portions of the entire specification of this patent, to any or all drawings, and to each claim.

Embodiments of the invention are directed to a system, apparatuses, and methods for enabling a third party application installed on a multi-tenant platform to utilize an external service, where that service requires a user to provide authentication credentials, without exposing those credentials to the third party application. The invention enables an extension of the platform's services, applications, and functionality via the use of the third party application, but without the risk that the application might expose the credentials to misuse or otherwise cause a breach of the security measures applicable to the data and/or services of a tenant, a tenant's users, or the platform itself.

In one embodiment, the invention is directed to a method for authenticating a user of a computing platform with an external service, wherein the method includes:
generating a user interface configured to permit a user to enter data corresponding to a credential;
receiving the data corresponding to the credential;
storing the data corresponding to the credential in a data store;
generating a credential token, the credential token identifying the stored data;
providing the credential token to an application installed on the computing platform;
receiving data from the application, the received data including the credential token and data identifying the external service;
using the credential token to access the data corresponding to the credential; and
providing the data corresponding to the credential to the external service.

In another embodiment, the invention is directed to an apparatus for authenticating a user of a computing platform with an external service, comprising:
an electronic processor configured to access a non-transitory computer readable medium and programmed to execute a set of instructions; and
the set of instructions stored in the non-transitory computer readable medium, wherein when executed by the electronic processor, the set of instructions cause the apparatus to implement a process for authenticating the user of a computing platform with the external service by
   generating a user interface configured to permit a user to enter data corresponding to a credential;
   receiving the data corresponding to the credential;
   storing the data corresponding to the credential in a data store;
   generating a credential token, the credential token identifying the stored data;
   providing the credential token to an application installed on the computing platform;
   receiving data from the application, the received data including the credential token and data identifying the external service;
   using the credential token to access the data corresponding to the credential; and
   providing the data corresponding to the credential to the external service.

Other objects and advantages of the present invention will be apparent to one of ordinary skill in the art upon review of the detailed description of the invention and the included figures.

### BRIEF DESCRIPTION OF THE DRAWINGS

Various embodiments in accordance with the present disclosure will be described with reference to the drawings, in which:

FIG. 1 is a diagram illustrating elements of an example computing system architecture 100 in which an exemplary embodiment of the inventive system and methods may be implemented;

FIG. 2 is a diagram illustrating elements of a computing system architecture 200 in which an embodiment of the invention has been implemented;

FIG. 3 is a diagram illustrating the elements of an example secure credential service (SCS) 304 and its operating environment, in accordance with at least one embodiment of the invention;

FIG. 4 is a diagram illustrating elements of an example secure credential GUI component in accordance with an embodiment of the invention;

FIG. 5 is a diagram illustrating an example secure credential service application programming interface (API) 500 in accordance with at least one embodiment of the invention;

FIG. 6 is a flowchart or flow diagram illustrating an example process for the secure collection of credentials, in accordance with at least one embodiment of the invention;

FIG. 7 is a flowchart or flow diagram illustrating an example process for performing an authentication operation, in accordance with at least one embodiment of the invention; and

FIG. 8 is a diagram illustrating elements that may be present in a computer device and/or system 800 configured to implement a method and/or process in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying or requiring any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art.

Among other things, the present invention may be embodied in whole or in part as a system, as one or more methods, or as one or more devices. Embodiments of the invention may take the form of an entirely hardware implemented embodiment, an entirely software implemented embodiment or an embodiment combining software and hardware aspects. For example, in some embodiments, one or more of the operations, functions, processes, or methods described herein may be implemented by a suitable processing element (such as a processor, microprocessor, CPU, controller, etc.) that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

As will be described, in accordance with at least one embodiment of the invention, a secure credential service (SCS) is provided by a multi-tenant distributed computing service (or platform). The secure credential service enables an application or component provided by a third party vendor to act on behalf of a tenant (and/or a tenant's user or other suitable credentialed entity) without requiring direct access by the third party application or component to the corresponding authentication credentials. This removes a possible security risk that might arise from providing a third party application or component with access to authentication credentials and/or other private information of a user or tenant. As a result of using an embodiment of the invention, third party applications may be provided with an indirect and secure reference to credentials in a controlled manner. This may be used to permit the third party application to utilize the functionality of an external service, such as a banking service, governmental service, credit card processing service, shipping service, or utility service. Further, in one embodiment, tenants and/or users of tenant-customized services may be reassured (e.g., visually) that the provided credentials are being used in a safe and secure manner. By operating the SCS, the platform increases the functionality available to tenants and tenants' users since a greater range of third party applications and functions (and the associated external services) become available in a manner that provides security for user credentials.

In accordance with at least one embodiment of the invention, a platform-level mechanism of a software-as-a-service (SaaS) computing platform (e.g., a multi-tenant distributed computing system) may enable a third party application accessible through the platform to interact with an external service without a tenant and/or a tenant's user being required to trust the third party application with their authentication credentials (e.g., username and password, or other confidential data). In one embodiment, the platform may provide a graphical user interface (GUI) component that acquires the credentials (e.g., by permitting entry of a username and password into appropriate fields). The platform may securely store the credentials and provide an identifier, reference, and/or token (collectively, “credential token”) to the third party application. The credential token functions to enable the third party application to reference the securely stored credentials without having direct access to the credentials. This preserves the privacy and security of the credentials since they are not exposed (at least not in a clear text, or human or machine readable form) to the third party application.

At a later time the third party application may request that the platform authenticate a user with a specified external service using the stored credentials. This request may contain the credential token and one or more of a URL of the external service, a username or other identifier of an account associated with a user of the platform, and a description of the credential(s) requested. In response, the platform may use the token to access the referenced credentials and provide them to the external service using the URL and/or another interface with the external service (e.g., an API, email, application, data storage location, etc.). The platform may also provide the third party application with a form of authentication token (e.g., an authenticated session “cookie”) which functions to identify a “session” or transaction with the external service and provides a form of audit trail confirming that the platform has provided the credentials to the external service.

In accordance with at least one embodiment of the invention, the platform may require that certain security conditions or criteria be satisfied before performing the authentication operation with the external service (by providing the appropriate credentials). Possible (but non-limiting) examples of such security conditions or criteria include: that the third party application is authorized to request such an authentication process, that the original provider of the credentials is currently authenticated with the platform (e.g., “logged in” or satisfies another suitable condition), that the external service is associated with a specified network domain (e.g., an internet domain name or domain name on a “white” list, or one that is not associated with a domain on a “black” list), that the authentication attempt is occurring during a permitted time of day (or part of an existing session), or any suitable condition based on one or more authentication process related variables or parameters. Note that such security conditions or criteria may be specified by the platform, by the tenant, by the tenant's user, or by any combination of such entities. Alternatively, or in addition, the third party application may request a particular set of security conditions or criteria, which may then be approved or denied (either individually or as a group) by a tenant, user, or the platform.

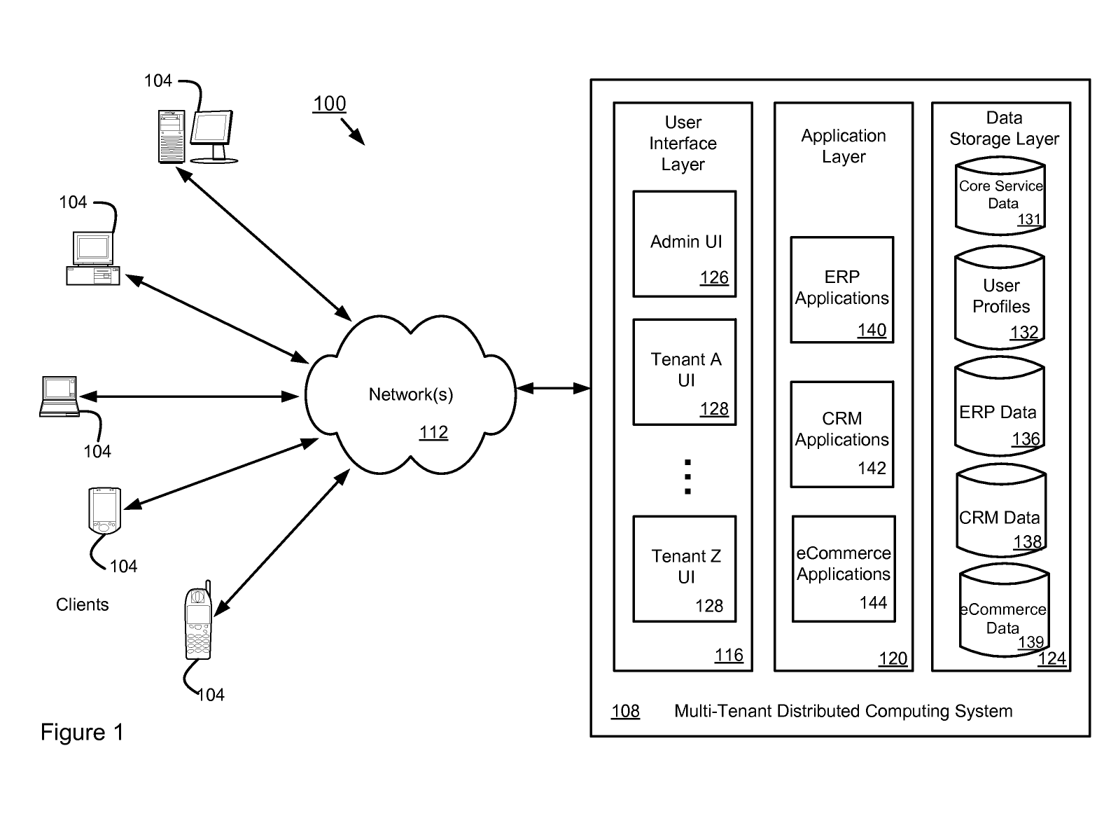

FIG. 1 is a diagram illustrating elements of an example computing system architecture 100 in which an exemplary embodiment of the inventive system and methods may be implemented. As shown in the figure, a variety of client applications (not shown) incorporating and/or incorporated into a variety of client computing devices 104 may communicate with a multi-tenant distributed computing system (e.g., an enterprise information system) 108 through one or more networks 112. Examples of suitable client computing devices 104 include personal computers, server computers, desktop computers, laptop computers, notebook computers, tablet computers, personal digital assistants (PDAs), smart phones, cell phones, and consumer electronics incorporating one or more computing device components, such as one or more electronic processors that may be programmed to execute a set of instructions. Examples of suitable networks 112 include networks including wired and wireless communication technologies, networks operating in accordance with any suitable networking and/or communication protocol, private intranets, and/or the Internet.

The multi-tenant distributed computing system 108 may include multiple processing tiers or layers, including a user interface layer 116, an application layer 120, and a data storage layer 124. The user interface layer 116 may provide tenant specific user interfaces 128 (such as “dashboards”), including graphical user interfaces and/or web-based interfaces. Note that a dashboard user interface may be advantageous for presenting enterprise information to users in a compact and more easily understandable form. Such enterprise information may include information provided by enterprise information applications or components, such as an enterprise resource planning (ERP) application 140, a customer relationship management (CRM) application 142, and/or an eCommerce application 144. Different users may have different access rights to enterprise information, with those rights being configured by an administrative user interface 126 and determined/defined in whole or in part by data contained in a user profile 132. Note that a user profile 132 may have an administrator configured portion and a user configured portion (e.g., user configurable preferences).

The tenant dashboard user interfaces 128 may include a default user interface for the system 108, as well as one or more user interfaces customized by tenants of the service. As noted, the dashboard user interfaces 128 interact with various ERP applications 140, CRM applications 142, and/or eCommerce applications 144 (or other suitable applications) to provide users with relevant information. The components of the application layer 120 may access data storage layer 124 to obtain the necessary data for an application and/or to access a user profile 132 to determine what data to provide to a specific user (e.g., based on the user's position within an organization, the user's access or security rights, etc.). The data storage layer 124 may include a core service data store 131 as well as a data store (or data stores) 136, 138, and 139 for storing tenant data (such as ERP data, CRM data, eCommerce data, and/or other suitable data). The data stores may be implemented with any suitable data storage technology, including structured query language (SQL) based relational database management systems (RDBMS). Each tier or layer (i.e., 116, 120, or 124) may be implemented by a distributed set of computers and/or computer components including computer servers. Multi-Tenant Distributed Computing System 108 may be considered a multi-tenant data processing environment or platform in which each of the multiple tenants are able to store relevant business related data and utilize the environment to have one or more desired data processing operations performed on the data.

As is known, both functional advantages and strategic advantages may be gained through the use of an integrated business system comprising ERP, CRM and other business capabilities, particularly where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone.

Such an integrated system provides benefits to the merchant as well. For example, when a customer initiates an online sales transaction via a browser-based interface, the integrated business system may process the order, update accounts receivable, update inventory databases and other ERP-based systems, and may also automatically update strategic customer information databases and other CRM-based systems. These modules and other applications and functional components may be integrated and executed by a single code base accessing one or more integrated databases as necessary, forming an integrated business management platform, with this integration further leveraged to provide additional advantages by incorporating inter-module communications.

However, each merchant (or other tenant entity using such an integrated platform) is unique, both in terms of their commercial offerings, desired customer demographics, and marketing techniques, but also in terms of their internal business organization and philosophies. Therefore, a truly robust integrated business solution (such as an enterprise data processing platform or multi-tenant data processing system) should preferably not only have a rich set of features, but also be customizable for each tenant/business' needs. Thus, it is desirable to provide users of such a system with the ability to develop custom software applications and/or to install third party applications that leverage the advantages of the functionality of an integrated business platform in the manner most desired by a particular tenant/user. Thus, the application tier 120 of the multi-tenant distributed computing system or platform 108 may provide an application server for executing customized and/or extended software applications, where such applications may be provided by a third party and used to process data in a manner desired by a particular tenant.

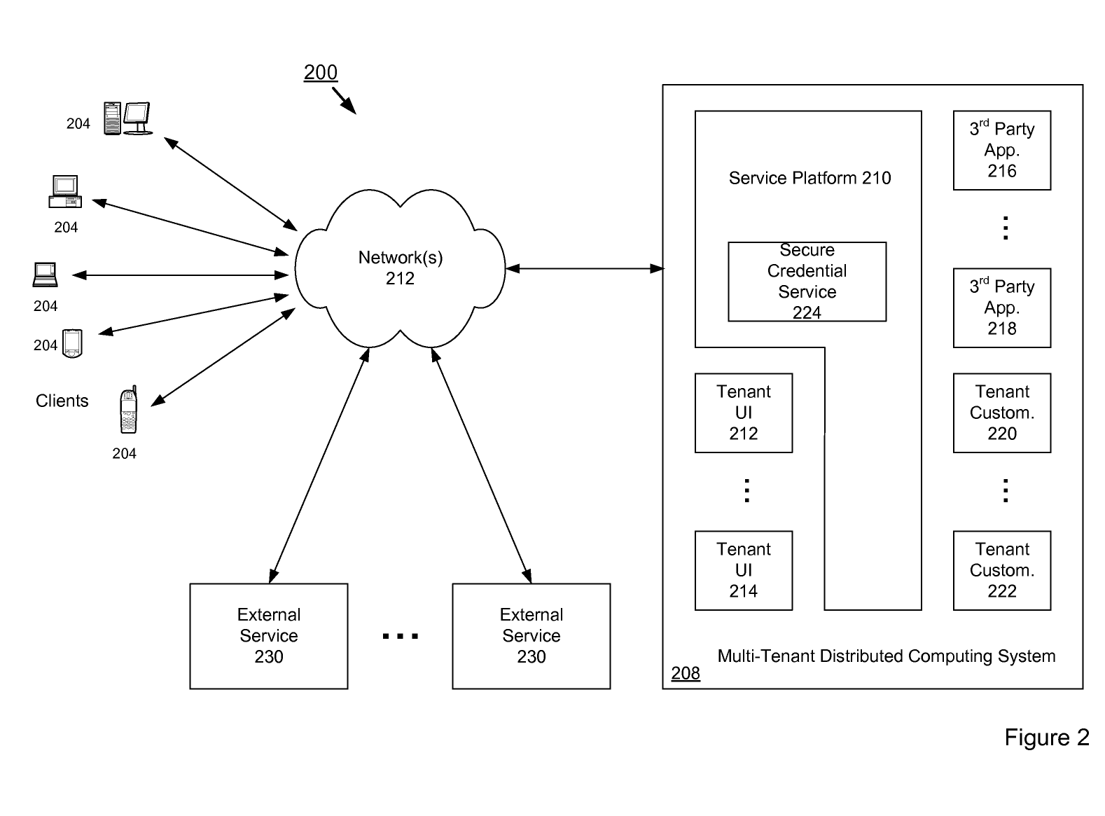

FIG. 2 is a diagram illustrating elements of a computing system architecture 200 in which an embodiment of the invention has been implemented. Note that for purposes of clarity FIG. 2 does not depict all of the elements described with reference to FIG. 1, although it should be understood that the system architecture of FIG. 1 represents a suitable architecture in which an embodiment of the invention could be implemented. In such a case, an example of the inventive secure credential service might be implemented as a part of application layer 120.

As shown in FIG. 2, a variety of clients (not shown) incorporating and/or incorporated into a variety of computing devices 204 may communicate with a multi-tenant distributed computing system 208 through one or more networks 212. For example, a client may incorporate and/or be incorporated into a client application implemented at least in part by one or more of the computing devices 204. Examples of suitable computing devices 204 include personal computers, server computers, desktop computers, laptop computers, notebook computers, tablet computers, personal digital assistants (PDAs), smart phones, cell phones, and consumer electronics incorporating one or more computing device components such as one or more processors. Examples of suitable networks 212 include networks that incorporate wired and/or wireless communication technologies, and networks operating in accordance with any suitable networking and/or communication protocol (e.g., a company intranet or the Internet).

The multi-tenant distributed computing system 208 may include a service platform 210, where such platform includes a set of one or more applications that are used to provide tenants with distinctive services (such as tenant-specific functionality, data processing capabilities, data presentation capabilities, etc.) for use by distinct sets of users. These applications may include customizable applications and/or extendible applications, such as an ERP application, CRM application or eCommerce application. System 208 may also include one or more applications developed by a third party (depicted as “3^{rd} Party App. 216 through 3^{rd} Party App. 218” in the figure). In some cases a third party application may interact with an external service 230 (e.g., a bank, government agency, utility, etc.) in order to provide a tenant with certain functionality, capabilities or services.

The system 208 may include multiple user interfaces including graphical user interfaces and/or web-based interfaces (depicted as “Tenant UI 212” through “Tenant UI 214” in the figure). The user interfaces (212 . . . 214) may include a default user interface for the system 208 and/or platform 210, as well as one or more user interfaces customized by one or more tenants of the system. The default user interface may include components enabling tenants to maintain custom user interfaces and otherwise administer their participation in the functions and services provided by the system. Note that a tenant may associate a particular customized user interface with a particular set of users. The functionality of a customized user interface may be implemented, at least in part, with one or more tenant customization components (depicted as “Tenant Custom. 220” through “Tenant Custom. 222” in the figure). The tenant customization components (220 . . . 222) may enable a tenant to customize the system or platform functions (to an extent that is typically controlled or limited by the system platform). As is conventional, note that the ellipses in the figure indicate that any suitable number of components may be incorporated.

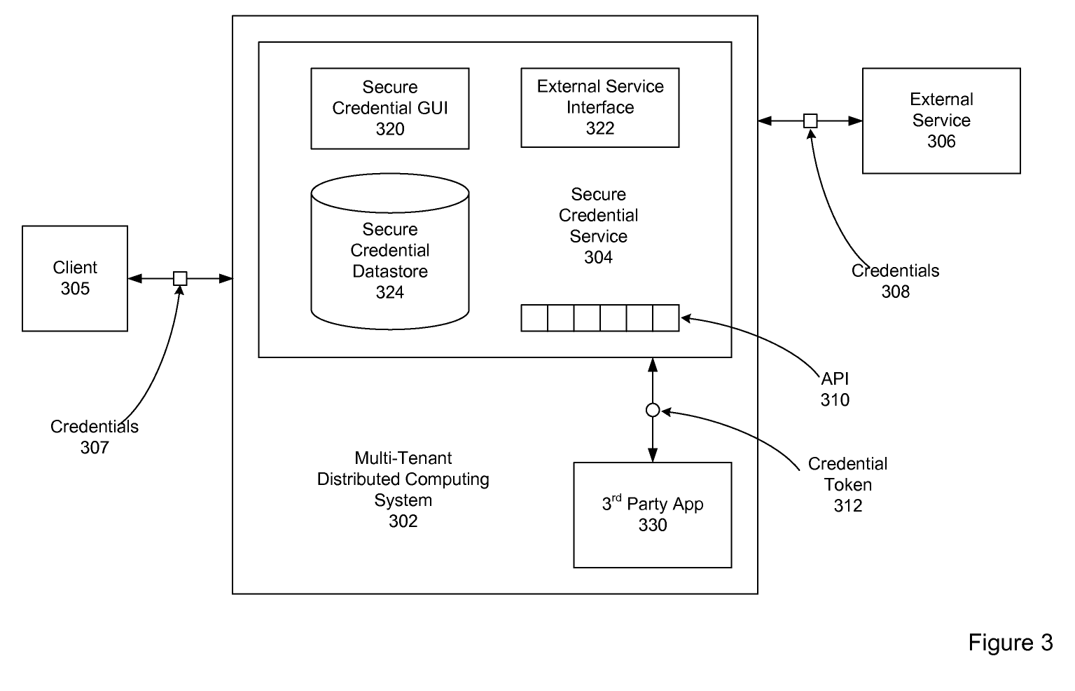

As noted, the computing system 208 may accept and permit installation of one or more applications provided by a third party vendor (depicted as “3^{rd} Party App. 216” through “3^{rd} Party App. 218” in the figure), where such applications may provide a variety of desirable functions or data processing capabilities. For example, such third party applications may interact with one or more external services 230 through the network(s) 212 to enhance the functionality of the multi-tenant system. Tenant customizations (220 . . . 222) may reference and/or incorporate one or more of the third party applications. The service platform 210 may incorporate an embodiment of the inventive secure credential service (SCS) 224, configured at least to enable one or more third party applications (216 . . . 218) to interact with an external service 230 on behalf of a credentialed entity (e.g., a tenant, tenant employee, or customer of a tenant) without the 3^{rd} party application having direct access to the authentication credentials of the entity. Note that an example secure credential service 224 is described in more detail with reference to FIG. 3.

As was described with reference to FIG. 1, the multi-tenant distributed computing system 208 may include multiple processing tiers or layers, including a user interface tier, an application tier and a data storage tier (each of which may be part of system 208, although not explicitly shown in the figure). Each tier or layer may be implemented with a set of computers and/or computer components including computer servers. The data storage tier may include a core service data store as well as a data store dedicated to each tenant. The system 208 may provide shared services and resources to enable client processes to interact with one or more embedded hosted, multi-tenant applications (such as ERP, CRM, or eCommerce applications). The client process may interact with the embedded application(s) through an application programming interface (API) that may provide methods to search, read and write data, methods to communicate with external systems and other methods for in process (non-data accessing) computations. Information exchange between the embedded application's data store and the client process may occur at the business object level. For example, business objects may correspond to multiple underlying database tables. Each data access operation provided by the API may have guaranteed integrity, for example, corresponding to the atomicity, consistency, isolation and durability (ACID) properties of database transactions.

The computing system 208 may provide a high level application (such as a business application) at least in part with a set of business objects in a business object layer. The high level application may be customized by a tenant of the system with tenant managed resources, including custom settings, custom program code (such as scripts), custom program modules, third party applications, and any suitable custom configuration components. Execution environments may be instantiated for the custom program code and/or custom program modules. For example, where the custom program code includes code written using an interpreted programming language (such as a scripting language), an interpreter may instantiate execution environments for scripts and/or associated tasks or jobs. The layers and/or components of the distributed computing system may be implemented, at least in part, with data stores and/or computing resources (e.g., computer operating system resources) in a data storage layer and/or a computer operating system layer.

FIG. 3 is a diagram illustrating the elements of an example secure credential service (SCS) 304 and its operating environment, in accordance with at least one embodiment of the invention. A third party application 330 installed on the multi-tenant distributed computing system 302 may have a need for tenant and/or user credentials, for example, to authenticate with an external service 306. The third party application 330 may interact with the secure credential service 304, for example, through an application programming interface (API) 310 of the secure credential service to inform the secure credential service of the need for the credentials in order to authenticate a tenant/user with the external service. The secure credential service 304 may maintain a secure credential GUI component 320 configured at least to indicate to a tenant and/or user that credentials are being requested in a secure manner. For example, the secure credential GUI component 320 may have a standardized appearance associated with secure credential collection. The secure credential GUI component 320 may indicate a context for the credential request, where such context may include one or more of a name of the requesting third party application, a name of the external service, and a reference to a set of conditions under which the credentials may (or will) be used.

For example, such use conditions may include that the credentials may be used only when the user and/or tenant are authenticated with the multi-tenant distributed computing service, that the credentials may only be used to authenticate with a specified set of one or more network locations (e.g., corresponding to IP addresses, URLs), or that the credentials may only be used within a specified schedule (e.g., times of day, days of week, thereby defining a period in which they are valid). Other example use conditions may depend on a type of data being provided to the external service (e.g., the credentials may only be used when ERP and/or CRM data is being provided to the external service for processing, etc.). In general, the use conditions may arise from a policy of one or more of the secure credential service, the multi-tenant distributed computing system, or be specified by the tenant, the user, or the third party application.

The secure credential GUI component 320 may be integrated into a tenant GUI and/or a third party app GUI accessible by a user. The secure credential service 304 may add the secure credential GUI component 320 to a specified GUI in response to a request by the third party application 330. The third party application 330 may have control over placement and/or appearance of the secure credential GUI component 320 within the specified GUI. Alternatively, the secure credential GUI component 320 may have a standardized placement and/or appearance to aid in user recognition and usage of the secure credential GUI component. In response to a request (or by action initiated by a tenant or user), the tenant and/or user may provide credentials 307 (and optionally use conditions) using a suitable client 305 to the secure credential service 304 through the secure credential GUI component 320. The secure credential service 304 may receive and securely store the credentials and use conditions in a suitable secure credential datastore 324. For example, the credentials and/or the data in the secure credential datastore 324 may be encrypted.

Responsive to collection of the credentials (or if already collected, accessing of the stored credentials), a corresponding credential token 312 may be provided to the third party application 330 that requested the collection or indicated a need for the credentials. For example, the credential token 312 may correspond to a globally unique identifier (GUID) that references (or can be used to determine) a location within datastore 324. The credential token 312 may incorporate and/or be accompanied by contextual information, such as the tenant and/or user that provided the corresponding credentials and/or the use conditions associated with the credentials. Significantly, in accordance with at least one embodiment of the invention, the credential token 312 supplied to the third party application 330 cannot be used to authenticate the tenant or user with the external service 306. In accordance with at least one embodiment of the invention, the credential token 312 is a GUID or other type of data that identifies and/or locates the credentials in the secure credential datastore 324, to which the third party application 330 does not have direct access. The secure credential service 304 may require that the third party application 330 interact with the service through the API 310.

Once in possession of the credential token 312, the third party application 330 may use the token to request that the secure credential service 304 authenticate the party whose credentials are represented by the token with the external service 306 using the corresponding credentials. The third party application 330 may interact with an element of the API 310 to request the secure credential service 304 to retrieve the credentials corresponding to the credential token from the datastore 324. Before attempting the authentication process with the external service 306, the secure credential service 304 may confirm that any use conditions associated with the credentials and/or the credential token are satisfied. If the use conditions are not satisfied, then the secure credential service 304 may prevent or otherwise inhibit the authentication process. Otherwise, the credentials may be retrieved from the secure credential datastore 324, decrypted or otherwise processed as necessary, and provided to an external service interface module 322 configured at least to manage the authentication process.

As part of this function, the external service interface module 322 may manage the transfer of the credentials 308 to the external service 306. Note that although in some cases the credentials 308 provided to the external service 306 may be of the same format and content as the credentials 307 provided to the secure credential service 304, in other cases the credentials 308 provided to the external service 306 may be the result of performing certain processing operations on the original credentials 307. For example, such processing operations may include reformatting, translating, encoding, or otherwise processing the credentials 307 to place them into a form suitable for use by external service 306. Note that suitable parties may be notified of the success or failure of events related to the authentication process.

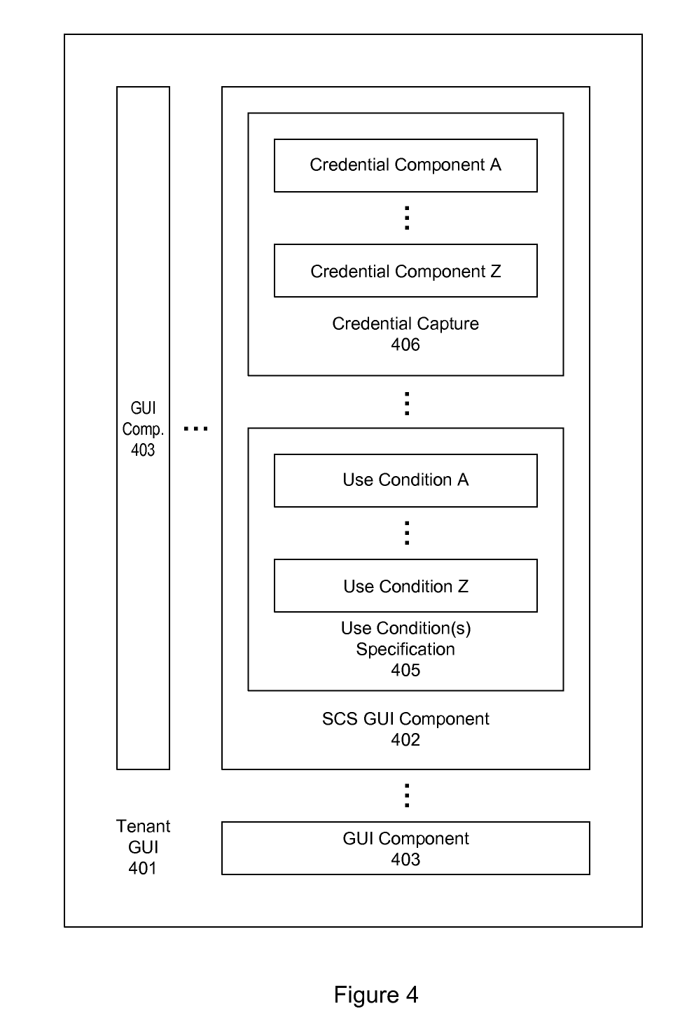

FIG. 4 is a diagram illustrating elements of an example secure credential service GUI component 402 in accordance with an embodiment of the invention. In this example, the secure credential service GUI component 402 is embedded in a tenant GUI 401 that also incorporates other GUI components 403. For example, the GUI components 403 may correspond to “portlets” and/or windows used to display and/or permit interaction with different sets of information and/or application functions. The secure credential service GUI component 402 may have a standardized and/or distinctive appearance to better inform and/or alert the user that the component 402 may be used to collect credentials for use in a later authentication process. The secure credential service GUI component 402 may include a credential capture subcomponent 406 configured at least to enable a user to input authentication credentials, and a use condition(s) specification subcomponent 405 configured at least to enable a user to create, view, and/or edit one or more authentication credential use conditions (depicted as “Use Condition A . . . Use Condition Z” in the figure).

The credential capture subcomponent 406 may include one or more credential component input fields (depicted as “Credential Component A . . . Credential Component Z” in the figure), such as username and password. The credential capture subcomponent 406 may permit entry and/or capture of any suitable credential components, including alphanumeric user identification data, passwords, account details, and/or user biometric data. Note that the credential components may include a “certificate” issued by a recognized certificate service, such as a SSL client certificate issued by a bank or government agency. The use condition(s) specification subcomponent 405 may present one or more read-only use conditions. Alternatively, or in addition, the use condition(s) specification subcomponent 405 may present one or more editable use conditions (e.g., by providing a field in which a use condition may be created or selected). When editable use conditions are present and/or addable, the user may interact with the use condition(s) specification subcomponent 405 to edit and/or specify a use condition. The use condition(s) specification subcomponent 405 may utilize any suitable GUI component and/or idiom to present and/or allow specification of a use condition, including editable text areas, checkboxes, radio buttons, lists, scrollable lists and drop-down lists.

The secure credential service GUI 402 component may correspond to one or more data structures and/or sets of computer-executable instructions. Such data structures and/or computer-executable instructions may be rendered and/or interpreted by any suitable GUI presentation mechanism, including visual displays, audio speakers, etc. The secure credential service GUI component 402 need not be entirely graphical, for example, the user may interact with the component using voice inputs.

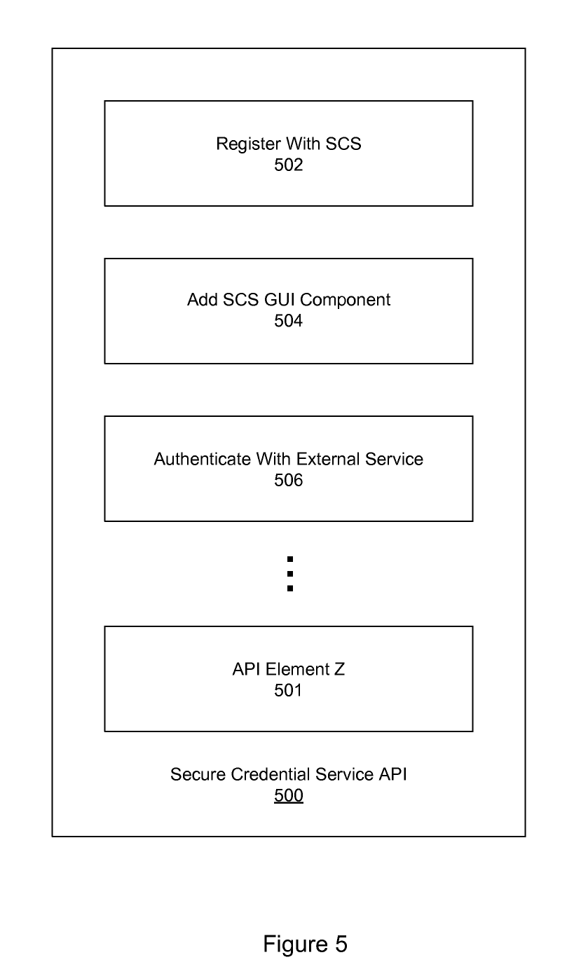

FIG. 5 is a diagram illustrating an example secure credential service application programming interface (API) 500 in accordance with at least one embodiment of the invention. The API 500 may include any suitable number of interface elements 501. The interface elements may be of any suitable type, including function calls of a suitable computer programming language, remote function calls, programmatic objects, elements of a data structure, messages of a communication protocol, etc. The API 500 may include a register with secure credential service interface element 502 that registers a third party application with the secure credential service. For example, registration may initialize one or more data structures maintained by the secure credential service that correspond to the registering application and/or subscribe the application to notifications of secure credential service events that are relevant to the application, including credential collection events, credential revocation events, use condition change events, credential token events, authentication success/failure events, error notifications, etc.

The API 500 may include an add SCS GUI component element 504 that enables a third party application to add the SCS GUI component to a graphical user interface, such as a tenant-customized GUI. The add SCS GUI component element 504 may enable the application to customize and/or request customization of the appearance and/or placement of the SCS GUI component with respect to the containing GUI. Alternatively, or in addition, the add SCS GUI component element 504 may enable the application to specify and/or request a set of use conditions that apply to credentials collected with the SCS GUI component. As discussed with reference to FIG. 3, in one embodiment, upon credential collection the SCS GUI component and/or the secure credential service may send a credential collected notification to the third party application that includes a corresponding credential token.

The API 500 may further include an authenticate with external service element 506 that enables a third party application to request that the secure credential service authenticate a tenant/user with an external service using a collected credential. The third party application may include as part of the request a reference to the appropriate credential (e.g., a corresponding credential token), and may specify the entity with which to authenticate (e.g., the external service as identified by a URL, API, or other form of identification). Upon successful authentication, the secure credential service may provide the third party application with access to (or a record of) the authenticated communication session. For example, the secure credential service may provide the application with a suitable authentication session “cookie” (which may be provided by the external service or generated by the secure credential service).

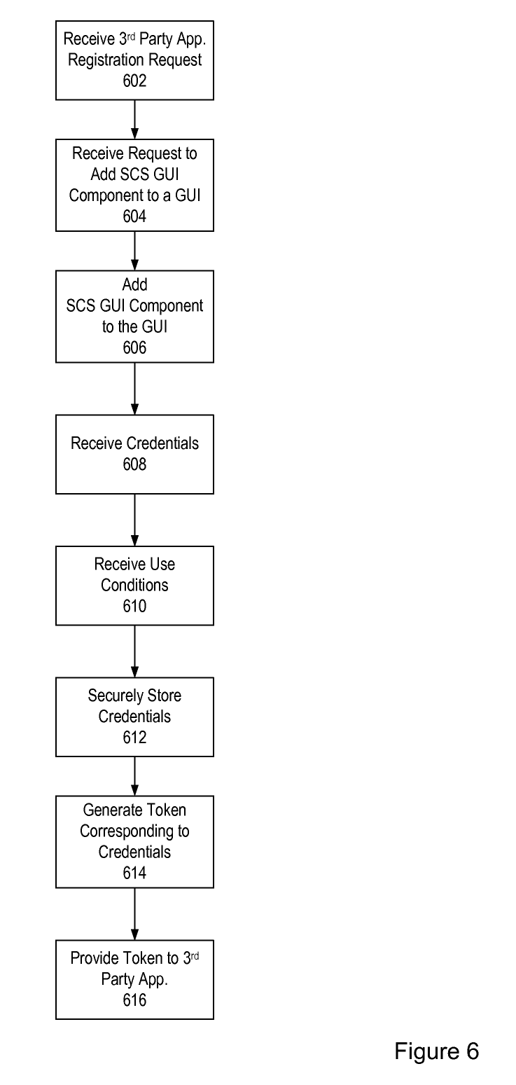

The following provides additional information regarding the functions, operations, processes, methods, or procedures that may be performed by the secure credential service. FIG. 6 is a flowchart or flow diagram illustrating an example process for the secure collection of credentials, in accordance with at least one embodiment of the invention. As shown in the figure, a request to register a third party application may be received 602, for example, through the API of the secure credential service. In response the third party application may be registered. A request to add a SCS GUI component to a GUI may be received 604, for example, through the API of the secure credential service. In response, the SCS GUI component may be added to the specified GUI, for example, by the secure credential service GUI module of the secure credential service.

Credentials may then be provided or otherwise received 608. For example, the SCS GUI component may provide the credentials to the secure credential service in response to user interaction (such as data entry) with the SCS GUI component. Credential use conditions may also be received 610. For example, the SCS GUI component may provide one or more use conditions for the credentials to the secure credential service in response to user interaction (such as data entry, selection of one or more rules or constraints, etc.) with the SCS GUI component. The credentials and use conditions may be securely stored 612, for example, in the secure credential datastore. A credential token corresponding to the credentials (and use conditions) may be generated 614 and provided to the third party application 616 that registered and/or added the SCS GUI component. For example, the secure credential service may generate the credential token as part of storing the credentials in the secure credential datastore. Alternatively, the credential token may be generated by the SCS GUI component as part of the credential collection process. The SCS GUI component may communicate with the secure credential service over a secure communication connection.

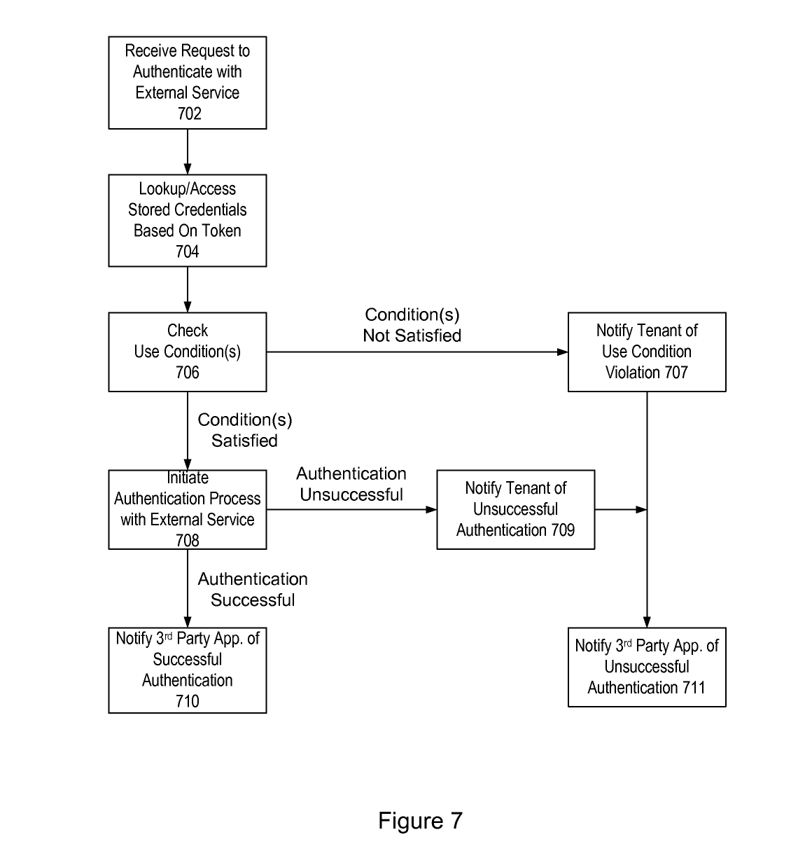

FIG. 7 is a flowchart or flow diagram illustrating an example process for performing an authentication operation, in accordance with at least one embodiment of the invention. As shown in the figure, a request to authenticate with an external service may be received 702. For example, a third party application may request that the secure credential service authenticate a tenant/user with a specified external service using credentials in the secure credential datastore. The desired credentials may be identified and/or the request for authentication indicated by the third party application providing a credential token that was previously generated by the secure credential service. A lookup or other form of access may be conducted 704 to find stored credentials and any use conditions, based at least in part on the credential token. For example, the credential token may be a GUID that can be used as a key or partial key to locate and/or decrypt the securely stored credentials. One or more use conditions may be accessed and checked 706. If a user condition is not satisfied, then the tenant and/or user may be notified of a use condition violation 707 and the third party application may be notified of an unsuccessful authentication 711. Otherwise, an authentication operation may be initiated with the external service 708. For example, the external service interface of the secure credential service may attempt to authenticate with the external service using the unencrypted (or otherwise processed) credentials. If the authentication succeeds, then the third part application may be notified of a successful authentication 710. Otherwise, the tenant 709, user and/or third party application 711 may be notified of the unsuccessful authentication attempt.

As described, in accordance with at least one embodiment of the invention, a user interface may be provided by which credentials can be obtained from an end user for secure storage and subsequent use as part of an authentication process with an external service. The credentials may be encrypted or otherwise encoded and/or stored, and a credential token or other form of identifier may be provided to a third party application that desires to access the external service. Opaque use of the credential by the third party application may thereby be enabled, thus ensuring that the third party application does not have direct access to the credentials. The user interface element for obtaining credentials may be added to a platform-maintained user interface in a manner similar to other user interface elements, for example, with a specific API for such user interface construction and/or customization.

Further and as described, in accordance with at least one embodiment of the invention, a UI component may be presented on behalf of a third party application responsive to an API call. Credential(s) and use condition(s) obtained using the UI component may be securely stored. A corresponding credential token may be generated and provided to the third party application. Responsive to another API call with the credential token, an authentication process using the corresponding stored credentials may be executed when the corresponding use conditions are satisfied.

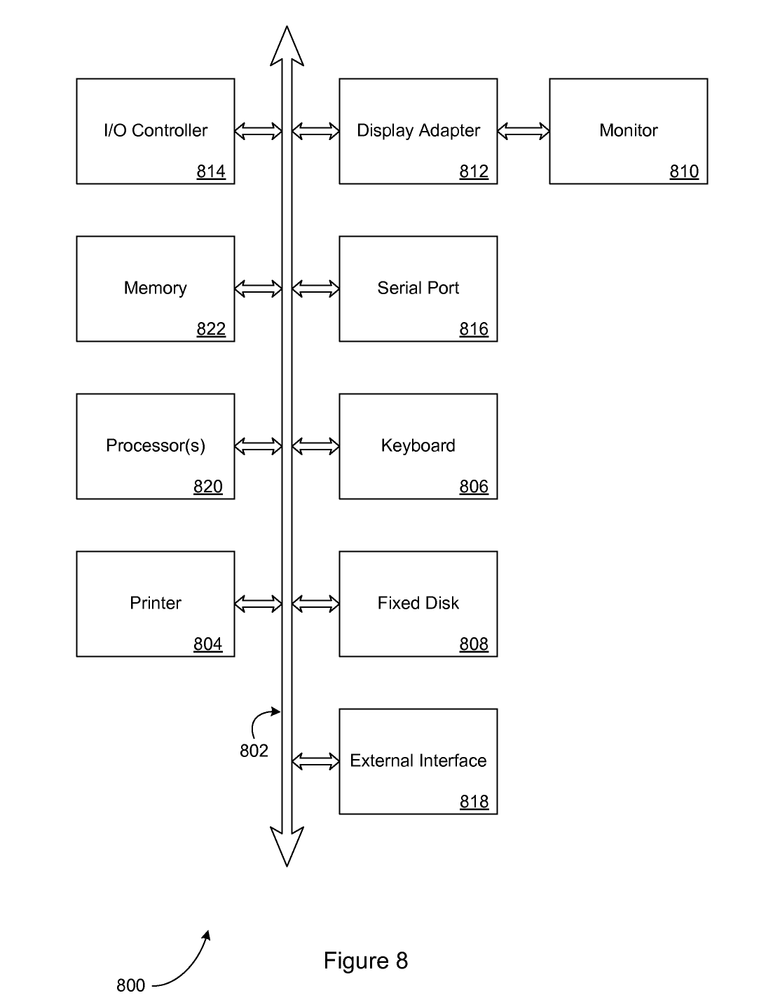

In accordance with at least one embodiment of the invention, the system, apparatus, methods, functions, processes, and/or operations described herein may be wholly or partially implemented in the form of a set of instructions executed by one or more suitably programmed computer processors, such as a central processing unit (CPU) or microprocessor. Such processors may be incorporated in an apparatus, server, client or other computing device operated by, or in communication with, other components of the system. As an example, FIG. 8 is a diagram illustrating elements that may be present in a computer device and/or system 800 configured to implement a method and/or process in accordance with some embodiments of the present invention. The subsystems shown in FIG. 8 are interconnected via a system bus 802. Additional subsystems include a printer 804, a keyboard 806, a fixed disk 808, and a monitor 810, which is coupled to a display adapter 812. Peripherals and input/output (I/O) devices, which couple to an I/O controller 814, can be connected to the computer system by any number of means known in the art, such as a serial port 816. For example, the serial port 816 or an external interface 818 can be utilized to connect the computer device 800 to further devices and/or systems not shown in FIG. 8 including a wide area network such as the Internet, a mouse input device, and/or a scanner. The interconnection via the system bus 802 allows one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Note that the methods, processes, operations, function, etc., depicted in the data flow diagram or flowchart illustrations can be implemented by computer program instructions. These program instructions may be provided to a processor to produce a machine, such that the instructions executing on the processor create a means for implementing the operations specified in the flowchart blocks. The computer program instructions may be executed by a suitably programmed processor to cause a series of operational actions to be performed by the processor to produce a computer implemented process for implementing the actions specified in the flowchart block or blocks. These program instructions may be stored on some type of machine readable storage media, such as a processor readable non-transitive storage media, or the like.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method for authenticating a user of a computing platform with an external service, comprising:
generating a user interface configured to permit a user to enter data corresponding to a credential;
receiving the data corresponding to the credential at the computing platform;
storing the data corresponding to the credential in a data store at the computing platform;
generating a credential token, the credential token identifying the stored data;
providing the previously-generated credential token to an application executing on the computing platform;
receiving data from the application, the received data including the previously-generated credential token and data identifying the external service that is external to the computing platform;
using the previously-generated credential token to access the data corresponding to the credential while preventing the application from accessing the credential; and
providing the data corresponding to the credential to the external service without providing the data corresponding to the credential to the application.

2. The method of claim 1, wherein the data corresponding to the credential includes one or more of a user name, a password, or an account identifier.

3. The method of claim 1, wherein the credential token identifies the stored data by including a location of the stored data in the token.

4. The method of claim 1, wherein the application installed on the computing platform is a third party application.

5. The method of claim 1, wherein the data identifying the external service is one or more of a Universal Resource Locator, a web-page address, a call to an Application Programming Interface, or an email address.

6. The method of claim 1, wherein the external service is one of a banking service, a government provided service, a transaction processing service, or a shipping service.

7. The method of claim 6, wherein the transaction processing service is a credit card or debit card processing service.

8. The method of claim 1, wherein the data corresponding to the credential includes one or more conditions on the use of the data.

9. The method of claim 8, further comprising:
determining if the one or more conditions on the use of the data are satisfied before providing the data corresponding to the credential to the external service.

10. The method of claim 8, wherein the one or more conditions include a condition on when the data may be used or a condition on an external service to which the data may or may not be provided.

11. An apparatus for authenticating a user of a computing platform with an external service, comprising:
an electronic processor configured to access a non-transitory computer readable medium and programmed to execute a set of instructions stored in the non-transitory computer readable medium, wherein when executed by the electronic processor, the set of instructions cause the apparatus to implement a process for authenticating the user of a computing platform with the external service, the process including:
generating a user interface configured to permit a user to enter data corresponding to a credential;
receiving the data corresponding to the credential at the computing platform;
storing the data corresponding to the credential in a data store at the computing platform;
generating a credential token, the credential token identifying the stored data;
providing the previously-generated credential token to an application that is executable on the computing platform;
receiving data from the application, the received data including the previously-generated credential token and data identifying the application that is external to the computing platform;
using the previously-generated credential token to access the data corresponding to the credential while preventing the external service from accessing the credential; and
providing the data corresponding to the credential to the external service without providing the data corresponding to the credential to the application.

12. The apparatus of claim 11, wherein the data corresponding to the credential includes one or more of a user name, a password, or an account identifier.

13. The apparatus of claim 11, wherein the credential token identifies the stored data by including a location of the stored data in the token.

14. The apparatus of claim 11, wherein the application installed on the computing platform is a third party application.

15. The apparatus of claim 11, wherein the data identifying the external service is one or more of a Universal Resource Locator, a web-page address, a call to an Application Programming Interface, or an email address.

16. The apparatus of claim 11, wherein the external service is one of a banking service, a government provided service, a transaction processing service, or a shipping service.

17. The apparatus of claim 16, wherein the transaction processing service is a credit card or debit card processing service.

18. The apparatus of claim 11, wherein the data corresponding to the credential includes one or more conditions on the use of the data.

19. The apparatus of claim 18, further comprising:
determining if the one or more conditions on the use of the data are satisfied before providing the data corresponding to the credential to the external service.

20. The apparatus of claim 18, wherein the one or more conditions include a condition on when the data may be used or a condition on the external service to which the data may or may not be provided.
